(19) United States
(12) Patent Application Publication
(10) Pub. No.: US 2009/0125959 A1
(43) Pub. Date: May 14, 2009

(54) METHOD AND APPARATUS OF CABLE MODEM INITIALIZATION USING QUEUE-DEPTH-BASED BAND REQUEST FRAME IN HFC NETWORKS

(76) Inventors: Hye Ju OH, Daejeon (KR); Seung Eun HONG, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/099,844

(22) Filed: Apr. 9, 2008

(30) Foreign Application Priority Data
Nov. 14, 2007 (KR) 10-2007-0116013

(51) Int. Cl. H04N 7/173

(52) U.S. Cl. 725/111

(57) ABSTRACT

A cable modem initialization method and apparatus using a queue-depth-based band request frame in a Hybrid Fiber Coax (HFC) network relates to a method and apparatus of requesting a Cable Modem Transmission System (CMTS) for band allocation so that a cable modem supporting a plurality of transceiving channels may transmit upstream data in an HFC network. A method of transmitting the queue-depth-based band request frame that requests the band allocation by a byte length of a transmission buffer when the cable modem performs an initialization process is provided.

### CROSS-REFERENCE TO RELATED APPLICATION

This application claims priority from Korean Patent Application No. 10-2007-0116013, filed on Nov. 14, 2007, in the Korean Intellectual Property Office, the entire disclosure of which is incorporated herein by reference.

### BACKGROUND OF THE INVENTION

1. Field of the Invention

The present invention relates to a method by which a cable modem may efficiently transmit data in a Hybrid Fiber Coax (HFC) network, and more particularly, to a cable modem initialization scheme using a queue-depth-based band request frame in an HFC network.

This work was supported by the IT R&D program of MIC/IITA [2006-S-019-02, The Development of Digital Cable Transmission and Receive System for 1 Gbps Downstream].

2. Description of Related Art

A security authentication procedure necessary for initialization setting and a plurality of message transceiving procedures necessary for accessing a Dynamic Host Configuration Protocol (DHCP) server, a Time-of-Day (ToD) server, and a Trivial File Transfer Protocol (TFTP) server and performing a registration procedure are required for an initialization process of a cable modem. Accordingly, in order to transceive a message, the cable modem is required to transmit a band allocation request message each time transmission data is accumulated in a buffer. However, even the cable modem using a plurality of transceiving channels is required to use a mini slot-based band request frame until an initialization setting operation before registration is completed, similar to the cable modem using a single channel, and cannot use segmentation using a Continuous Concatenation and Fragmentation (CCF) scheme.

As described above, even though the cable modem using the plurality of transceiving channels may utilize a mechanism using channel bonding, the cable modem using the plurality of transceiving channels cannot sufficiently indicate its own abilities by performing an operation identical to an operation of the cable modem using the single channel in the initialization setting operation before the registration is completed.

Also, many band allocations are possible in a Data Over Cable Service Interface Specifications (DOCSIS) 3.0 version using a plurality of channels, however realization of the many band allocations is difficult in a conventional frame structure. Also, the cable modem in a DOCSIS system using the single channel creates much overhead due to encapsulation. Accordingly, a method and apparatus to solve the above-described problems is necessary.

### SUMMARY OF THE INVENTION

An aspect of the present invention provides an efficient data transmission method. Many message-transceiving processes are performed for performing an initialization process of a cable modem, and a request of a band necessary for transmitting a message and resource allocation from a Cable Modem Transmission System (CMTS) are required. In this case, a Data Over Cable Service Interface Specifications (DOCSIS) 3.0-based cable system needs more data transmission than that of a previous system and also needs many interactions with the CMTS during a process of registering and presetting the cable modem. Therefore, an efficient data transmission method is needed.

Another aspect of the present invention also provides a cable modem initialization scheme using a queue-depth-based band request frame in a Hybrid Fiber Coax (HFC) network. In a DOCSIS system using a single channel, a cable modem encapsulates and transmits data using a fragmentation header and a concatenation header by a resource allocated by a CMTS, and permits a piggyback resource request for additional packets in only a final fragment of concatenated Media Access Control (MAC) Protocol Data Units (PDUs). This method causes much overhead due to encapsulation and is inefficient in a resource efficiency aspect. The present invention is disclosed for solving the above-described disadvantage.

According to an aspect of the present invention, there is provided a method of controlling a CMTS in a cable modem initialization scheme using a queue-depth-based band request frame in an HFC network, the method including: transmitting, to a cable modem, an initialization setting message for initial access and channel information acquisition; receiving, from the cable modem, a ranging request (B-INIT-RNG-REQ) message for ranging; identifying, from the received ranging request message, a message transmission mode denoting whether the cable modem supports a plurality of transceiving channels; determining whether to permit a queue-depth-based band request to the cable modem after identifying the message transmission mode; and allocating, for the cable modem, a queue-depth-based band when transmission of a queue-depth-based band request frame is permitted.

According to another aspect of the present invention, there is provided a method of controlling a cable modem, the method including: a cable modem receiving an initialization setting message from a CMTS; transmitting, to the CMTS, a ranging request (B-INIT-RNG-REQ) message including information denoting whether a plurality of transceiving channels is supported, and performing ranging when the cable modem supports the plurality of transceiving channels; transmitting a queue-depth-based band request frame (QD-REQ Frame) to allocate, for the cable modem, a band necessary for data transmission; and transmitting data in the band allocated from the CMTS based on the transmitted frame.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates an initialization procedure of a Cable Modem (CM) in a Data Over Cable Service Interface Specifications (DOCSIS) cable network;

FIG. 2 illustrates a form of a band request frame previously used in DOCSIS 2.0 using a single channel according to an exemplary embodiment of the present invention;

FIG. 3 illustrates a form of a band request frame previously used in DOCSIS 3.0 using a plurality of transceiving channels according to an exemplary embodiment of the present invention;

FIG. 4 illustrates a traffic segmentation of a CM using a plurality of transceiving channels according to an exemplary embodiment of the present invention;

FIG. 5 is a flowchart illustrating operations of a Cable Modem Transmission System (CMTS) according to an exemplary embodiment of the present invention;

FIG. 6 illustrates a use determination method of a queue-depth-based band request frame in an initialization process using a ranging message according to an exemplary embodiment of the present invention;

FIG. 7 illustrates a MAP message for resource allocation of a CM according to an exemplary embodiment of the present invention; and

FIG. 8 illustrates an information element of a MAP message according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

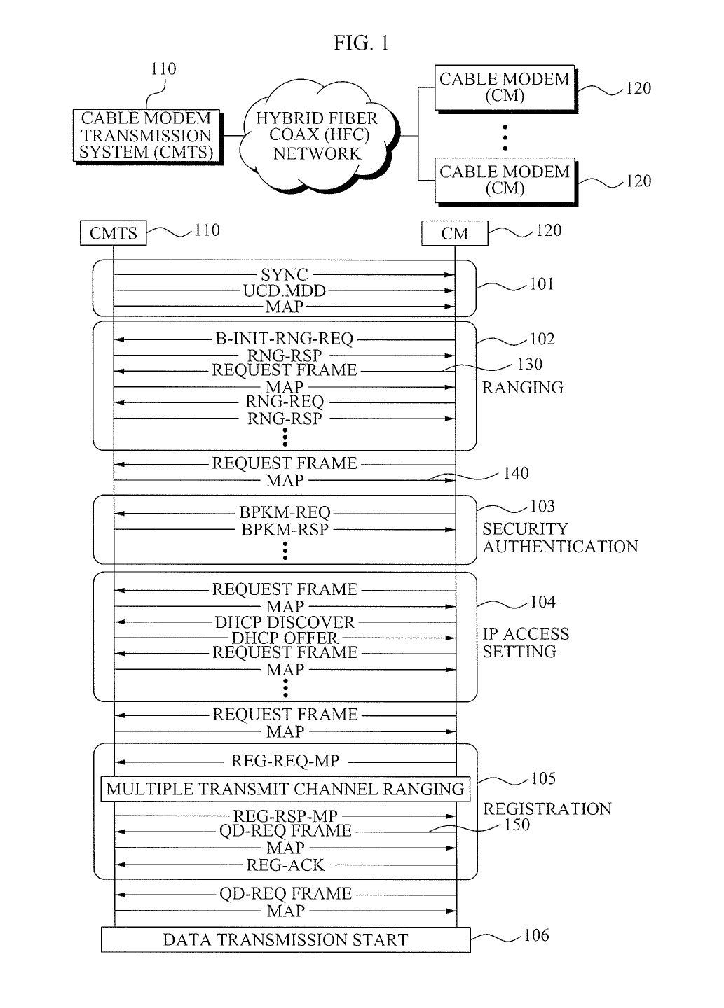

FIG. 1 illustrates an initialization procedure of a Cable Modem (CM) in a Data Over Cable Service Interface Specifications (DOCSIS) cable network.

Hereinafter, referring to FIG. 1, the initialization procedure of the CM in the DOCSIS cable network is described.

The present invention is based on the DOCSIS cable network. Here, DOCSIS are standard interfaces of the CM being an apparatus for processing data input/output between a cable television (TV) operating enterprise and a computer of an individual or a company, or a TV set, are known as “CableLabs authentication CMs”, and denote a modulation scheme and a protocol for two-way signal exchange on a cable.

DOCSIS started in CableLabs in 1995 and DOCSIS 1.0 was announced in July 1997. DOCSIS were subsequently ratified as an international standard by International Telecommunication Union-Telecommunication Standardization Sector (ITU-T) in March 1998. DOCSIS 1.1 and DOCSIS 2.0 were subsequently established, and DOCSIS 3.0 is currently being prepared for release targeted in 2008.

TABLE 1

| Classification | Feature | Speed (Mbps) |
|---|---|---|
| DOCSIS 1.0 | Initial standard of a CM | Upstream: |
| | Data transmission using a cable TV network (Best | 10 (maximum) |
| | Effort) | Downstream: |
| | Asymmetrical service provision | 40 (maximum) |
| | Simple Network Management Protocol (SNMP) | |
| | and remote software downloading support | |
| DOCSIS 1.1 | DOCSIS 1.0 compatibility | Upstream: |
| | Quality Of Service (QoS) guarantee for providing | 10 (maximum) |
| | additional services including Voice over Internet | Downstream: |
| | Protocol (VoIP) and the like | 40 (maximum) |
| | Security function intensification, CM authentication | |
| | function, SNMP version 3 (v3) support | |
| DOCSIS 2.0 | DOCSIS 1.0/1.1 compatibility | Upstream: |
| | Symmetrical service provision based on upstream band | 30 (maximum) |
| | extension | Downstream: |
| | New modulation scheme (Advanced-Time Division | 40 (maximum) |
| | Multiple Access (A-TDMA)/Synchronous Code | |
| | Division Multiple Access (S-CDMA)) support | |
| DOCSIS 3.0 | Wide bandwidth provision using channel bonding | Upstream: |
| | Internet Protocol version 6 (IPv6) (Dynamic Host | 120 (minimum) |
| | Configuration Protocol version 6 (DHCPv6)) | 6 MHz * 4 |
| | support | channel |
| | Multicasting function (Internet Group Management | Downstream: |
| | Protocol version 3 (IGMPv3)) support | 160 (minimum) |
| | Service Roaming, Committed Bit Rate, Video | 6 MHz * 4 |
| | Phone, IP-STP (Spanning Tree Protocol), improved | channel@256 |
| | security (Advanced Encryption Standard (AES), | Quadrature |
| | certificate invalidation function, and the like) | Amplitude |
| | | Modulation |
| | | (256-QAM) |

In Table 1, features of different DOCSIS versions are described.

DOCSIS 1.0 was an initially-commercialized international standard enabling a high-speed Internet service using a cable TV network, and since Internet search (web browsing) formed the bulk of Internet traffic in those days, DOCSIS 1.0 included an asymmetrical data transmission structure in which an upstream speed was different from a downstream speed.

DOCSIS 2.0 was promoted for a symmetrical service including peer to peer (P2P), videoconferencing, remote diagnosis, remote education, and the like, and had a striking feature of supporting a maximum upstream speed of 30 Mbps, compared with a previous version supporting a maximum upstream speed of 10 Mbps.

DOCSIS 3.0 described in the present specification provides a minimum downstream speed of 160 Mbps and a minimum upstream speed of 120 Mbps using channel bonding technology for transmission speed improvement, and main features are introduction of a Modular-Cable Modem Transmission System (M-CMTS), IPv6 support, using Source-Specific Multicast (SSM) for multicasting (using IGMPv3), multicast QoS support, and the like. According to this standard, an integrated broadcast communication service based on various IPs may be provided via the cable TV network.

The initialization procedure of the CM in the DOCSIS cable network is performed with a CMTS 110, a CM 120, a band allocation request frame (Request Frame) 130, a MAP 140, a queue-depth-based band request frame (QD-REQ Frame) 150, a data transmission start 106, an initial preparation operation (synchronization process 101), a ranging operation (ranging process 102), a security authentication operation (security authentication process 103), an IP access setting operation (IP access setting process 104), a registration operation (registration process 105), and the like, and the exemplary embodiment is described below.

The CM 120 receives an initialization setting message via a downstream channel from the CMTS 110, receives a synchronization (SYNC) message from among the initialization setting message, and performs synchronization. When the synchronization process 101 is performed, the CM 120 acquires Media Access Control (MAC) Domain Description (MDD) information and an Uplink Channel Description (UCD) message, and receives a MAP message, and subsequently performs ranging.

The ranging denotes an aggregate of processes for maintaining a connection quality of a communication, in particular, the synchronization, and denotes a process for informing about a distance between the CMTS 110 and the CM 120, that is, a delay time and the like after each terminal CM registers itself in the CMTS 110 (reserves a channel bandwidth). However, timing adjustment, power control, frequency error control, and the like are simultaneously performed during this process.

The CM 120, which may use the plurality of transceiving channels when the ranging process 102 is performed, attempts the ranging process 102 by a Bandwidth Initialize Ranging Request (B-INIT-RNG-REQ) message. When the ranging process 102 is successfully completed, the CM 120 performs a security authentication process 103 using a Bandwidth Privacy Key Management (BPKM) message, and performs an IP access setting process 104 by acquiring a configuration information file, information related to configuration information, an IP address of the CM 120, IP addresses of a Time-of-Day (ToD) server, a Trivial File Transfer Protocol (TFTP) server, and the like using a DHCP message.

In this case, after the CM 120 accesses the ToD server using information received from a DHCP server and acquires time information and date information, the CM 120 attempts to access the TFTP server. When the accessing of the TFTP server is completed, the CM 120 downloads the configuration information file necessary for a registration process 105 of the CM 120. The CM 120 subsequently transmits a registration request message (REG-REQ MP) using the downloaded configuration information file. When all settings are completed without an error as a result of a registration response message (REG-RSP MP) received from the CMTS 110, a registration process 105 and an initialization process (synchronization process 101) are completed by transmitting a registration acknowledgment message (REG-ACK) including a successful completion message.

When the above-described process is performed, since a plurality of CMs 120 accesses one CMTS 110 and transmits data by a burst signal in an upstream channel of a Hybrid Fiber Coax (HFC) network, the CMTS 110 divides a competition section and a reserved section using the MAP 140, and allocates a resource to the CM 120. The CM 120 transmits a band allocation request frame (Request Frame) 130 necessary for successful message transmission during initialization setting, and transmits a message after the resource is allocated using the MAP 140.

In this instance, since the CMTS 110 is unaware of a number of necessary bands and a time of needing the band, the band is allocated based on the band request frame received from the CM 120. In this instance, after the CM 120 supporting a bonding channel is permitted to use the plurality of transceiving channels via a registration process 105, the CM 120 uses a queue-depth-based band request frame (QD-REQ). In previous processes, that is, processes ranging from the ranging process 102 to the registration process 105, the band is allocated using a mini slot-based band request frame (Request Frame).

However, the present invention also provides a method of using a mechanism used when operating with the channel bonding from the initialization setting operation so that the CM 120 using the plurality of transceiving channels in the HFC network may efficiently transmit the data.

First, the CMTS 110 transmits a message of SYNC information, MAP information, UCD information, and MDD information for initial access and channel information acquisition of the CM 120. When the CMTS 110 receives a ranging request (B-INIT-RNG-REQ) message, being transmitted by the CM 120 and including information denoting whether the plurality of transceiving channels is supported, the CMTS 110 subsequently verifies whether the corresponding CM 120 supports the transmission of the queue-depth-based band request frame, and determines whether to permit the transmission of the queue-depth-based band request frame and data transmission using a Continuous Concatenation and Fragmentation (CCF) scheme during an initialization setting process. In this case, the CMTS 110 reports the above-described information to the CM 120 by using a ranging response (RNG-RSP) message.

When the CM 120 supports transmission of a plurality of transceiving messages, the CMTS 110 sets a mode as a queue-depth-based band request message receiving mode in the ranging response (RNG-RSP) message, and allocates the MAP to transmit the data by various burst profiles, that is, a type code (an Interval Usage Code (IUC)) 5/6/9/10/11.

When the CM 120 receives transmission permission information of the queue-depth-based band request (QD-REQ) frame from the ranging response (RNG-RSP) message of the CMTS 110, the CM 120 requests resource allocation using the queue-depth-based band request frame for next message transmission. Also, the CM 120 starts transmitting the data using the burst profile allocated by the CMTS 110 using the MAP (106).

However, when the CM 120 may not transmit the queue-depth-based band request (QD-REQ) frame, or when the transmission of the queue-depth-based band request (QD-REQ) frame is permitted after the registration even though the transmission is possible, the CMTS 110 marks corresponding information in the ranging response (RNG-RSP) message, transmits the corresponding information, and sets a mode as a mini slot-based band request message receiving mode. Also, the CMTS 110 composes the MAP by permitting only the IUC 5/6 in upstream data burst transmission.

A method of controlling the CM 120 during a subsequent process of FIG. 1 according to an exemplary embodiment of the present invention is described below.

The CM 120 receives an initialization setting message via a downstream channel from the CMTS 110, performs synchronization based on a SYNC message from among the initialization setting message, and subsequently acquires UCD information, MDD information, and a MAP message.

The CM 120 transmits, to the CMTS 110, the ranging request (B-INIT-RNG-REQ) message including information denoting whether the plurality of transceiving channels is supported, and performing the ranging when the CM 120 supports the plurality of transceiving channels.

In this instance, the ranging request (B-INIT-RNG-REQ) message includes a MAC management message header (4 bytes), a capability flag field (1 byte), an identification (MD-DS-SG-ID) field (1 byte) denoting a downlink MAC domain service group of the CM 120, a downstream channel ID field (1 byte), and an upstream channel ID field (1 byte). The capability flag field includes information about whether the CM 120 supports fragmentation (1 bit), whether to support Early Authentication and Encryption (EAE) (1 bit), whether to support the plurality of transceiving channels (QD-REQ), other reserved bits (5 bits), and the like.

The CM 120 transmits a queue-depth-based band request (QD-REQ) frame to allocate, for the CM 120, a band necessary for data transmission, and transmits data in the band allocated from the CMTS 110 based on the transmitted frame.

In this case, the CCF scheme is used for efficient transmission, and this is a scheme of sequentially dividing a segment header and data accumulated in a queue, in MAC Protocol Data Units (PDUs) of the band allocated from the CMTS 110 without a fragmentation header or a concatenation header after the CM 120 is registered to use the plurality of transceiving channels, padding a segment with data, and transmitting the data after registering the CM to use the plurality of transceiving channels, waiting for next resource grant for the data remaining after the transmitting; and transmitting the data by attaching the segment header subsequent to the previously transmitted data when the next resource is granted by a MAP.

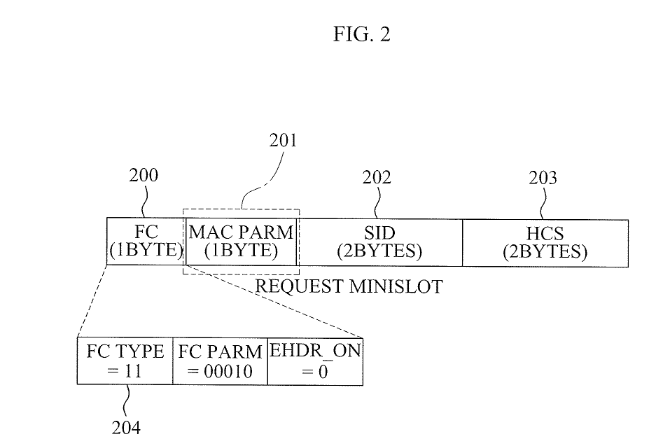

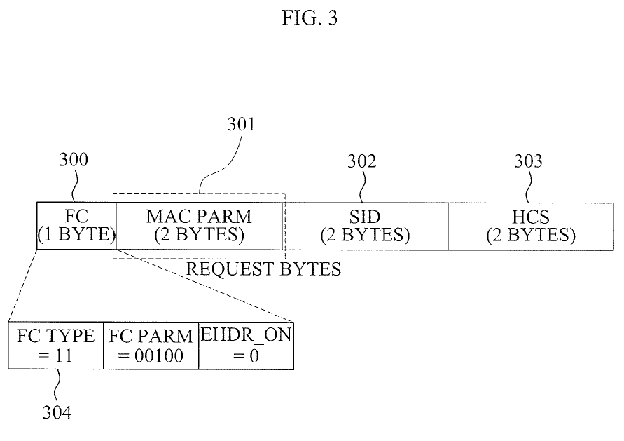

FIG. 2 and FIG. 3 illustrate forms of a band request frame used in DOCSIS.

Hereinafter, referring to FIG. 2 and 3, the forms of the band request frame previously used in DOCSIS 2.0 and DOCSIS 3.0 using a single channel are described.

A DOCSIS band request MAC frame according to the present invention includes Frame Controls fields (FCs: MAC header type definition) 200 and 300, MAC parameters (MAC PARMs) fields 201 and 301, Service Identifiers (SIDs) fields 202 and 302, MAC Header Check Sequence (HCS) fields 203 and 303, FC type fields (a MAC frame control type field) 204 and 304, and the like. The exemplary embodiment of the DOCSIS band request MAC frame is described below.

FIG. 2 and FIG. 3 illustrate forms of a band allocation request frame 130 used by a CM for a resource allocation request, and illustrate header structures of a MAC frame. The CMTS 110 and the CM 120 illustrated in FIG. 1 transceive the data using the MAC frame being a basic transmission unit in an upstream channel and a downstream channel. A MAC frame structure includes a MAC header defining contents of the MAC frame, and a data PDU of which a depth and existence are determined by the MAC header. The MAC frame is transmitted by attaching a physical media dependant sublayer overhead before the MAC header in the case of the upstream channel, and attaching a Motion Picture Experts Group (MPEG) transmission header in the case of the downstream channel.

The band request frame (FC Type 204 and 304) of FIG. 2 and FIG. 3 is a frame having a MAC management header as FC Type=11, and not attaching the data PDU. Here, when the FC type is ‘11’, the MAC management header is used for transmitting a message for managing the MAC frame, and a MAC management message transmitted to the CM 120 by the CMTS 110 in a downstream channel is referred to as the MAP 140. The CMTS 110 defines a band of an upstream channel so that the CM 120 may transmit data by transmitting the MAP 140 via the downstream channel. The CMTS 110 indicates SIDs allocated to the corresponding CM 120 in the SID fields 202 and 302, and indicates the band necessary for the CM 120 in the MAC PARM field of 1 byte 201 or the MAC PARM field of 2 bytes 301.

FIG. 2 illustrates the frame form previously used in DOCSIS 2.0 using the single channel, and the frame form has the MAC PARM field 201 of 1 byte. When the CMTS 110 is requested for a resource, the data is transmitted by calculating the necessary resource in the data to be transmitted based on a physical overhead including a preamble, Forward Error Correction (FEC), and a guard time, and indicating this by a mini slot unit.

FIG. 3 illustrates a queue-depth-based band request frame used when a CM 120 operating based on DOCSIS 3.0 supporting a plurality of transceiving channels is set to use the plurality of transceiving channels in an initial registration process, and the queue-depth-based band request frame has the MAC PARM field 301 of 2 bytes. When the CM 120 requests resource allocation using the queue-depth-based band request frame, the CM 120 requests the CMTS 110 for only the data accumulated in a transmission buffer of the CM 120 by a byte unit not considering the physical overhead necessary for the data transmission of the CM 120. Since the CM 120 has the MAC PARM field of 2 bytes in this case, different from FIG. 2, the CM 120 may request more band allocations than the CM 120 using the single channel.

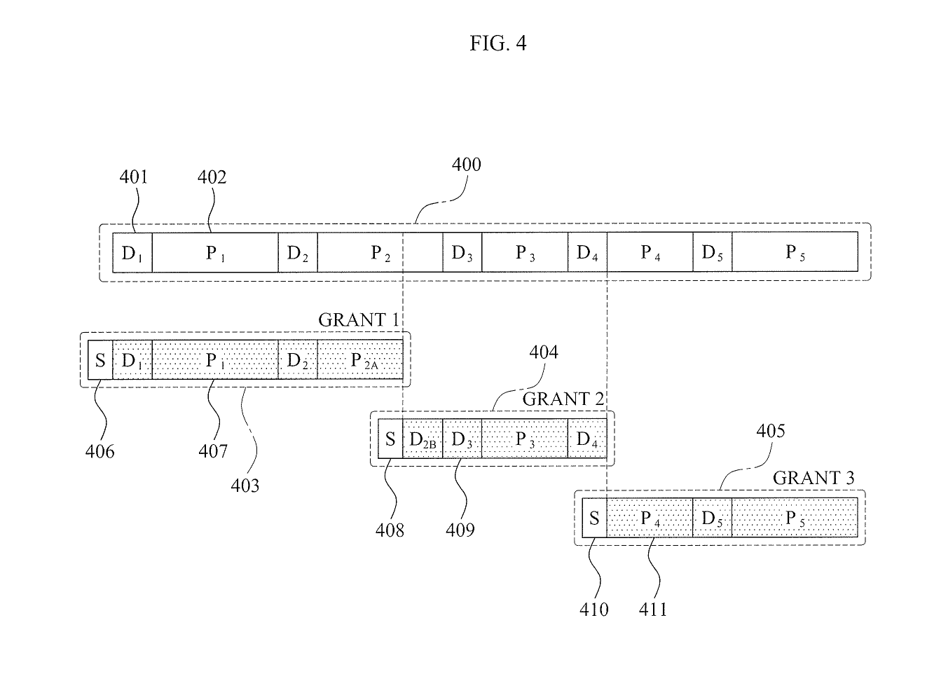

FIG. 4 illustrates a traffic segmentation of a CM using a plurality of transceiving channels according to an exemplary embodiment of the present invention.

Hereinafter, referring to FIG. 4, the traffic segmentation of the CM using the plurality of transceiving channels according to the present exemplary embodiment of the present invention is described.

The traffic segmentation of the CM using the plurality of transceiving channels according to the present invention includes data accumulated in a queue 400, data 401 and 409, parameters 402, 407, and 411, segment headers 406, 408, and 410, and the like. The exemplary embodiment of the traffic segmentation is described below.

In a DOSIS system using a single channel, the CM encapsulates the data using a fragmentation header and a concatenation header by the resource allocated by the CMTS, transmits the data, and permits a piggyback resource request for additional packets in only a final fragment of MAC PDUs in which the piggyback resource request is concatenated. This method causes much overhead due to encapsulation and is inefficient in a resource efficiency aspect.

Therefore, in the DOCSIS system using the plurality of transceiving channels according to the present invention, the CM uses a CCF scheme of accumulating the data in MAC PDUs of the band allocated by the CMTS without the fragmentation header or the concatenation header. Also, the CM may request a plurality of resources using a segment header, and request any channel related to a corresponding service flow as the resource.

The CMTS having received a queue-depth-based band request frame from the CM calculates an overhead for the resource requested by the CM, and grants the resource to the CM.

Here, the traffic segmentation denotes a consecutive mini slot group allocated to an identical service flow in an identical channel, and is stipulated as a physical parameter of a corresponding channel and an IUC type of a corresponding segment based on a physical layer feature. Resource grant to the CM using a bonding channel includes each segment (resource grants 403, 404, and 405), and the resource may be granted by being divided into a plurality of channels included in an identical channel combination group based on the resource request of the CM.

When the CM receives the resource grant 403 from the CMTS, the CM sequentially divides the segment header 406 and the data accumulated in the queue 400 for the allocated byte, pads a segment with data, and transmits the data. The data remaining after the transmitting waits for a next resource grant 404. When the next resource grant 404 is received by a MAP, the CM transmits the data 409 by attaching the segment header 408 subsequent to the previously transmitted data 401. This operation is possible after the CM is registered to use the plurality of transceiving channels.

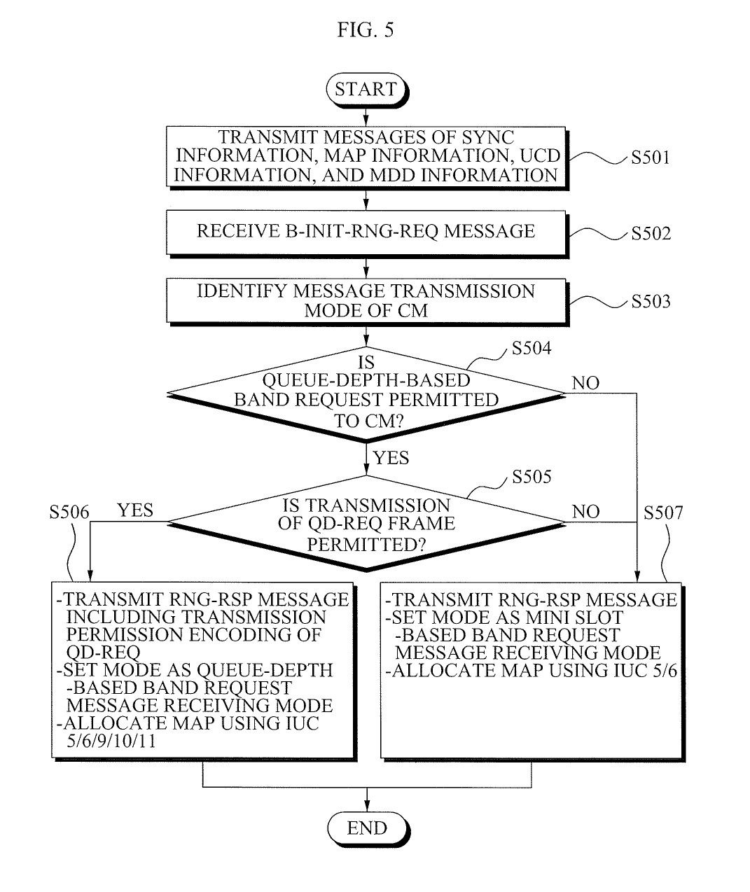

FIG. 5 is a flowchart illustrating operations of a CMTS according to an exemplary embodiment of the present invention.

First, in operation S501, a CMTS transmits, to a CM, an initialization setting message including SYNC information, MAP information, UCD information, MDD information message, and the like, for initial access and channel information acquisition. When the CMTS 120 subsequently receives a ranging request (B-INIT-RNG-REQ) message, the message being transmitted by the CM to the CMTS, for ranging including information denoting whether a plurality of transceiving channels is supported in operation S502, the CMTS identifies, from the received ranging request message, a message transmission mode denoting whether the CM supports the plurality of transceiving channels in operation S503.

In operation S504, the CMTS determines whether to permit a queue-depth-based band request to the CM after identifying the message transmission mode. In this instance, the CMTS verifies whether the corresponding CM supports the transmission of the queue-depth-based band request frame, determines whether to permit the transmission of the queue-depth-based band request frame and data transmission using a CCF scheme during an initialization setting process based on a verification result, and reports a determination result to the CM by using a ranging response (RNG-RSP) message.

In operation S505, when the queue-depth-based band request is possible, the CMTS determines whether to permit the transmission of the queue-depth-based band request frame again. In operation S506, when the transmission of the queue-depth-based band request frame is permitted, the CMTS allocates, for the CM, a queue-depth-based band.

In this instance, when the CMTS allocates, for the CM, the queue-depth-based band, the CMTS transmits a ranging response (RNG-RSP) message including a transmission permission encoding of the queue-depth-based band request (QD-REQ), thereby reporting the above-described information to the CM. When the CM supports transmission of a plurality of transceiving messages, the CMTS sets a mode as a queue-depth-based band request message receiving mode, and composes a MAP to allocate a resource by various burst profiles using an IUC 5/6/9/10/11.

When the CM receives transmission permission information of the queue-depth-based band request (QD-REQ) frame from the ranging response (RNG-RSP) message of the CMTS, the CM requests resource allocation using the queue-depth-based band request frame for a next message transmission. Also, the CMTS transmits the data using the burst profile allocated by the MAP.

However, when the CM may not transmit the queue-depth-based band request or the queue-depth-based band request (QD-REQ) frame, or when the transmission of the queue-depth-based band request (QD-REQ) frame is permitted after the registration even though the transmission is possible, the CMTS indicates corresponding information in the ranging response (RNG-RSP) message, transmits the corresponding information, and sets a mode as a mini slot-based band request message receiving mode. Also, in operation S507, the CMTS composes the MAP using only the IUC 5/6 in upstream data burst transmission.

Also, an apparatus for controlling a CMTS that performs the above-described method according to an exemplary embodiment of the present invention may include the following units.

The apparatus for controlling the CMTS may include a transceiving unit to transmit, to a CM, an initialization setting message including SYNC information, MAP information, UCD information, or MDD information message for initial access and channel information acquisition, and to receive, from the CM, a ranging request (B-INIT-RNG-REQ) message for ranging, a multi-channel support identification unit to identify, from the ranging request message received by the transceiving unit, a message transmission mode denoting whether the CM supports a plurality of transceiving channels, a queue-depth-based band request verification unit to verify whether the CM supports transmission of a queue-depth-based band request frame, a determination unit to determine whether to permit the transmission of the queue-depth-based band request (QD-REQ) frame and data transmission using a CCF scheme during an initialization setting process based on a verification unit result, and a band allocating unit to allocate, for the CM, a queue-depth-based band when the transmission of the queue-depth-based band request frame is permitted. Here, a process of performing the ranging may include a process of informing about a distance between the CM and the CMTS, that is, a delay time and the like, for example, after each terminal CM registers itself in the CMTS (reserves a channel bandwidth), timing adjustment, power control, frequency error control, and the like, are simultaneously performed during the ranging process.

Also, an apparatus for controlling a CM that performs a consecutive process corresponding to the CMTS according to an exemplary embodiment of the present invention may include the following units.

The apparatus for controlling the CM may include a transceiving unit to receive, by a CM, an initialization setting message from a CMTS, and to transmit, to the CMTS, a ranging request (B-INIT-RNG-REQ) message including information denoting whether a plurality of transceiving channels is supported when the CM supports the plurality of transceiving channels, a ranging performing unit to perform ranging based on the ranging request message, a queue-depth-based band request unit to transmit a queue-depth-based band request frame (QD-REQ Frame) to allocate, for the CM, a band necessary for data transmission, and a CCF performing unit to perform data transmission by a CCF scheme for the band allocated from the CMTS after the CM is registered to use the plurality of transceiving channels.

In this instance, the CCF scheme denotes Continuous Concatenation and Fragmentation and is a scheme of sequentially dividing a segment header and data accumulated in a queue, in MAC Protocol Data Units (PDUs) of the band allocated from the CMTS without a fragmentation header or a concatenation header after the CM is registered to use the plurality of transceiving channels, padding a segment with data, and transmitting the data after registering the CM to use the plurality of transceiving channels, waiting for a next resource grant for the data remaining after the transmitting, and transmitting the data by attaching the segment header subsequent to the previously transmitted data when the next resource is granted by a MAP.

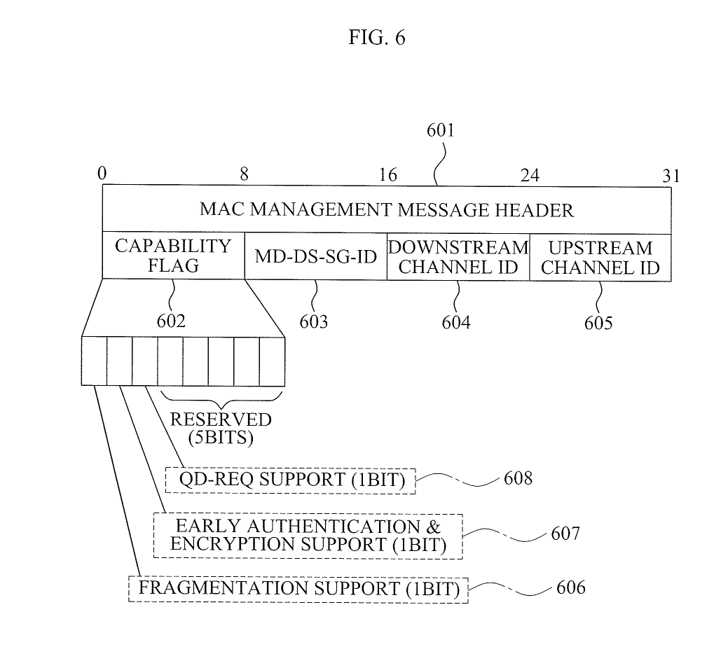

FIG. 6 illustrates a use determination method of a queue-depth-based band request frame in an initialization process using a ranging message according to an exemplary embodiment of the present invention.

Hereinafter, referring to FIG. 6, the use determination method of the queue-depth-based band request frame in the initialization process using the ranging message according to the present exemplary embodiment of the present invention is described.

FIG. 6 illustrates the use determination method of the queue-depth-based band request frame in the initialization process using the ranging message described with reference to FIG. 5, and illustrates a form of an initial message transmitted by a CM supporting a plurality of transceiving channels to a CMTS, that is, a B-INIT-RNG-REQ message. The B-INIT-RNG-REQ message includes at least one of a capability flag field 602 (1 byte), an identification (MD-DS-SG-ID) field 603 (1 byte) denoting a downlink MAC domain service group of the CM, a downstream channel ID field 604 (1 byte) receiving a UCD message, and an upstream channel ID field 605 (1 byte) transmitting a message after a MAC management message header 601 (4 bytes). Upper two bits of the capability flag field includes information about whether the CM supports fragmentation (fragmentation support field 606) and whether to support EAE (EAE & encryption support field 607), while other bits are set as reserved bits.

The present invention uses 1 bit from among reserved bits of the capability flag field 602 as QD-REQ support (QD-REQ support field 608) in order to report whether the CM supports the plurality of transceiving channels.

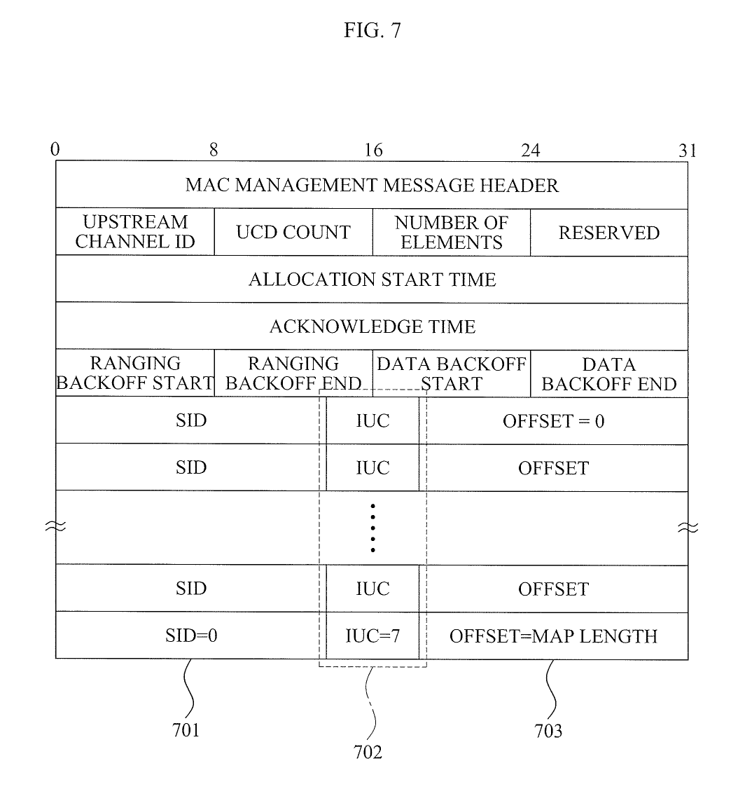

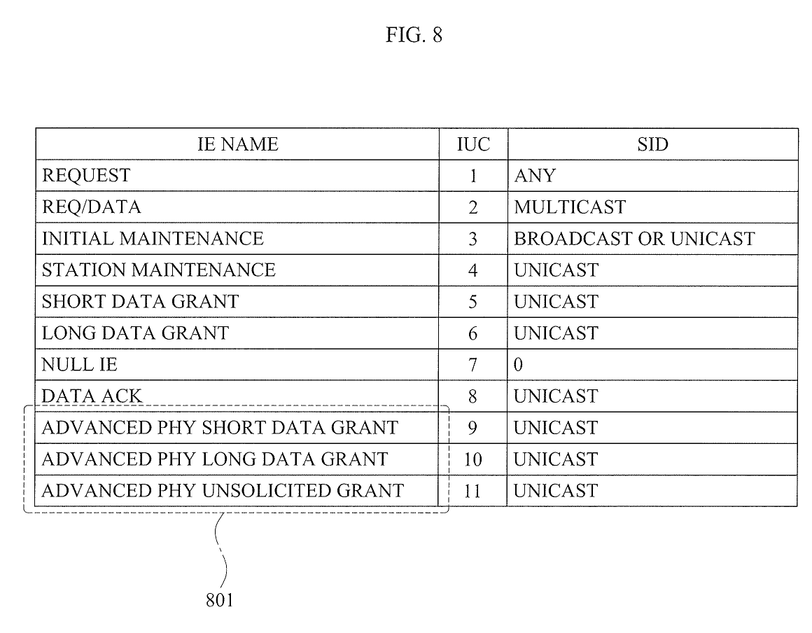

FIG. 7 and FIG. 8 illustrate a MAP message for resource allocation of a CM and an Information Element (IE) of the MAP message according to an exemplary embodiment of the present invention.

Hereinafter, referring to FIG. 7 and FIG. 8, the MAP message for the resource allocation of the CM and the IE of the MAP message according to the present exemplary embodiment of the present invention are described.

FIG. 7 illustrates the MAP message transmitted by a CMTS for the resource allocation of the CM. Here, the MAP message denotes a message for initialization between the CMTS and the CM, registration, band allocation, and the like in a MAC layer used for a cable network.

A MAP structure includes a header of a fixed length and an IE of a variable length, and the IE is classified into an SID of 14 bits, an IUC (a type code) of 4 bits, and starting offset of 14 bits.

Since an upstream channel of a DOCSIS cable network is generally a resource shared by several CMs, the CMTS allocates upstream data transmission section using the MAP, and the CM receives the MAP and transmits burst data to a corresponding section. In the upstream data transmission of the corresponding CM, a service is classified by an SID 701 of the MAP and an upstream data transmission time is determined by an offset 703. Also, an upstream burst transmission scheme is reported by defining an IUC 702. The IUC is described with reference to FIG. 8, and physical parameters of each code report are reported to the CM using a UCD message.

FIG. 8 illustrates an IE of a MAP message according to an exemplary embodiment of the present invention. IUCs 9, 10, and 11 (801) are codes used for a burst channel of a DOCSIS 2.0/3.0-mixed mode or a DOCSIS 2.0/3.0 burst channel. Since which mode the CM operates in is not determined in an initialization operation of the CM according to a conventional art, the IUCs 9, 10, and 11 are not used in MAP resource allocation. However, since the present invention randomly determines whether the plurality of transceiving channels is supported when the CM accesses a network, that is, the CM starts a ranging request, the IUCs 9, 10, 11 are permitted for the CM available as DOCSIS 3.0 and data is transmitted by various burst profiles.

The cable modem initialization scheme using the queue-depth-based band request frame in the HFC network according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, a DOCSIS 3.0-based cable system having a plurality of transceiving channels in an HFC network may use, during initialization, a queue-depth-based band request frame permitted after registration of a CM in order to efficiently process a registration and initialization process of the CM. Also, a CMTS may allocate a resource to the CM by various burst profiles.

Also, according to the present invention, a CM may eliminate a need for considering a physical overhead necessary for transmitting data, attach only a DOCSIS MAC header when generating an upstream transmission packet, store the DOCSIS MAC header in a transmission buffer, and request resource allocation by a byte length accumulated in a buffer by requesting the resource allocation using a queue-depth-based band request frame. In this instance, when the CM requests the resource allocation using the queue-depth-based band request frame, a CMTS may allocate a resource by various burst profiles based on an upstream channel state and a resource grant amount, and efficiently transmit data.

Also, according to the present invention, it is possible to have an advantage of relatively little encapsulation overhead, and to perform a resource request by piggyback at any time by permitting a CM to transmit data using a CCF scheme.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. Therefore, it is intended that the scope of the invention be defined by the claims appended thereto and their equivalents.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of controlling a Cable Modem Transmission System (CMTS), the method comprising:
transmitting, to a cable modem, an initialization setting message for initial access and channel information acquisition;
receiving, from the cable modem, a ranging request message for ranging;
identifying, from the received ranging request message, a message transmission mode denoting whether the cable modem supports a plurality of transceiving channels;
determining whether to permit a queue-depth-based band request to the cable modem after identifying the message transmission mode; and
allocating, for the cable modem, a queue-depth-based band when transmission of a queue-depth-based band request frame is permitted.

2. The method of claim 1, wherein the performing comprises:
transmitting a ranging response message including a transmission permission encoding of the queue-depth-based band request;
setting a mode as a queue-depth-based band request message receiving mode; and
composing a MAP to allocate a resource by using a predetermined portion of an Interval Usage Code (IUC).

3. The method of claim 1, further comprising:
displaying corresponding information in a ranging response message and transmitting the corresponding information when the queue-depth-based band request or the transmission of the queue-depth-based band request frame is prohibited, or when the transmission of the queue-depth-based band request frame is permitted after registration;
setting, for the cable modem, a mode as a mini slot-based band request message receiving mode; and
composing a MAP by using a predetermined portion of an IUC.

4. The method of claim 1, wherein the determining comprises:
verifying whether the cable modem supports the transmission of the queue-depth-based band request frame;
determining whether to permit the transmission of the queue-depth-based band request frame and data transmission using a Continuous Concatenation and Fragmentation (CCF) scheme during an initialization setting process based on a verification result; and
reporting a determination result to the cable modem by using a ranging response message.

5. The method of claim 1, wherein the initialization setting message includes at least one content of synchronization information, MAP information, uplink channel description information, and Media Access Control (MAC) domain description information.

6. An apparatus for controlling a CMTS, the apparatus comprising:
a transceiving unit to transmit, to a cable modem, an initialization setting message for initial access and channel information acquisition, and to receive, from the cable modem, a ranging request message for ranging;
a plural channel support identification unit to identify, from the received ranging request message, a message transmission mode denoting whether the cable modem supports a plurality of transceiving channels;
a queue-depth-based band request verification unit to verify whether the cable modem supports transmission of a queue-depth-based band request frame;
a determination unit to determine whether to permit the transmission of the queue-depth-based band request frame and data transmission using a CCF scheme during an initialization setting process based on a verification result; and
a band allocating unit to allocate, for the cable modem, a queue-depth-based band when the transmission of the queue-depth-based band request frame is permitted.

7. A method of controlling a cable modem, the method comprising:
a cable modem receiving an initialization setting message from a CMTS;
transmitting, to the CMTS, a ranging request message including information denoting whether a plurality of transceiving channels is supported, and performing ranging when the cable modem supports the plurality of transceiving channels;
transmitting a queue-depth-based band request frame to allocate, for the cable modem, a band necessary for data transmission; and
transmitting data in the band allocated from the CMTS based on the transmitted frame.

8. The method of claim 7, wherein the receiving comprises:
performing synchronization by receiving a synchronization message from the CMTS; and
acquiring at least one message of MAP information, uplink channel description information, and MAC domain description information when the synchronization is performed.

9. The method of claim 7, wherein the ranging request message includes a MAC management message header, a capability flag field, an identification (ID) field denoting a downlink MAC domain service group of the cable modem, a downstream channel ID field, and an upstream channel ID field.

10. The method of claim 9, wherein the capability flag field includes at least one piece of information about whether the cable modem supports fragmentation, whether to support Early Authentication and Encryption (EAE), whether to support the plurality of transceiving channels, and other reserved bits.

11. The method of claim 7, wherein the transmitting of the data comprises:
sequentially dividing a segment header and data accumulated in a queue, in MAC Protocol Data Units (PDUs) of the band allocated from the CMTS without a fragmentation header or a concatenation header after the cable modem is registered to use the plurality of transceiving channels, padding a segment with data, and transmitting the data after registering the cable modem to use the plurality of transceiving channels;
waiting for a next resource grant for the data remaining after the transmitting; and
transmitting the data by attaching the segment header subsequent to the previously transmitted data when the next resource is granted by a MAP.

12. An apparatus for controlling a cable modem, the apparatus comprising:
a transceiving unit to receive, by a cable modem, an initialization setting message from a CMTS, and to transmit, to the CMTS, a ranging request message including information denoting whether a plurality of transceiving channels is supported when the cable modem supports the plurality of transceiving channels;
a ranging performing unit to perform ranging based on the ranging request message;
a queue-depth-based band request unit to transmit a queue-depth-based band request frame to allocate, for the cable modem, a band necessary for data transmission; and
a CCF performing unit to perform data transmission by a CCF scheme for the band allocated from the CMTS after the cable modem is registered to use the plurality of transceiving channels.
